(19) United States
(12) Patent Application Publication
(10) Pub. No.: US 2006/0130622 A1
(43) Pub. Date: Jun. 22, 2006

(54) Circular blade and methods for using same

(75) Inventor: Dean S. Holmes, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/020,686

(22) Filed: Dec. 22, 2004

(51) Int. Cl. B26D 1/00; B26D 3/00

(52) U.S. Cl. 83/13

(57) ABSTRACT

A circular blade having a plurality of rigid polymeric cutting teeth having a hardness not greater than 130 Rockwell M. The circular blade is useful for removing sealant material from elongated openings.

### FIELD OF INVENTION

The present invention relates generally to a circular blade. More particularly, the present invention relates to circular blade for removing sealant material from substrates.

### BACKGROUND

Elastomeric sealants or coatings are frequently applied to interior and/or exterior structural surfaces of manufactured articles in order to seal, eliminate or minimize corrosion, mitigate surface cracks or protect the surfaces from impact or chemical attack. For example, butt joints between external panels of an aircraft skin are frequently filled with elastomeric sealants or coatings in order to eliminate leaks. In the event of an inevitable need for repair, however, these elastomeric sealants or coatings must be removed in order to render the underlying substrates accessible for the necessary maintenance procedures. These coatings may be removed mechanically or chemically. It is generally desired that the removal process avoid damage to the surrounding and underlying structural surfaces.

Frequently employed mechanical devices for the removal of elastomeric sealants include manual scraper blades such as those commercially available from Exacta Plastics Incorporated (Sun Valley, Calif.), as well as similar devices with customized profiles to facilitate access to confined areas. The use of these manual scraper blades are time-intensive and labor-intensive, especially if the area requiring removal is relatively large.

Other mechanical devices for the removal of elastomeric sealants include plastic rotary cutting tools with an integral mandrel for use with hand-held power drills. Commercially available plastic rotary cutting tools include those available from 3M Company, St. Paul, Minn., and marketed under various trade designations, including, for example, “3M BRAND SR CUTTER”, described in 3M Company product bulletin number 61-5002-8020-3. The geometries of these plastic rotary cutting tools enable them to cut both perpendicularly and parallel to their axis of rotation, however, their ability to maneuver and function in small crevices is limited.

Commercially available chemical means (i.e., strippers) are also used either alone or in conjunction with the manual scrapers described above, to remove such sealants. Such chemical products include those that are commercially available under the trade designation “SKYRESTORE”, manufactured by Elixair International Limited and commercially available from Aerosafe Products, Incorporated, Marietta, Ga. Use of such strippers, with or without manual scrapers, can also be time consuming. Generally, such strippers include organic solvents that may be undesirable due to their potential to cause disposal difficulties and atmospheric contamination.

There is a continuing need to provide inexpensive articles and methods for their use in removing elastomeric sealants from substrates, particularly elastomeric sealants from narrow elongated openings.

### SUMMARY

The present invention relates generally to a circular blade. More particularly, the present invention relates to a circular blade for removing sealant material from elongated openings.

In one aspect, the present invention provides a circular blade comprising a substantially planar body having a center portion and a peripheral portion. The peripheral portion comprises a plurality of rigid polymeric cutting teeth having a thickness in the range of about 0.5 to 4 millimeters and a hardness not greater than 130 Rockwell M. In some embodiments, the center portion comprises a polymeric material.

In some embodiments, the rigid polymeric cutting teeth comprise a thermoplastic. In some embodiments, the rigid polymeric cutting teeth comprise a thermoset.

In some embodiments, the rigid polymeric cutting teeth comprise a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide. In other embodiments, the rigid polymeric cutting teeth consist essentially of a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide.

In another aspect, the present invention provides a cutting tool comprising a circular blade having rigid polymeric cutting teeth. In another aspect, the present provides a cutting tool comprising a plurality of circular blades.

In another aspect, the present invention provides a circular blade consisting essentially of a rigid polymeric body having a thickness in the range of about 0.5 to 4 millimeters and a hardness not greater than 130 Rockwell M. In some embodiments, the rigid polymeric body comprises a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide.

In another aspect, a method for using the circular blade of the present invention to remove material from a substrate is provided. In some embodiments, the method is used to remove a sealant from a metal substrate. In some embodiments, the substrate is part of an aircraft.

The above summary of the present invention is not intended to describe each disclosed embodiment or every implementation of the present invention. The Figures and the detailed description that follow more particularly exemplify illustrative embodiments.

### BRIEF DESCRIPTION OF THE DRAWING

FIG. 1 is an elevational view of an exemplary embodiment of the present invention;

FIG. 2 is a perspective view of an exemplary embodiment of the present invention mounted on a right-angle drill to remove sealant from a butt joint in a substrate; and

FIG. 3 is a perspective view a dado blade formed by combining three exemplary circular blades of the present invention.

These figures, which are idealized, are not to scale and are intended to be merely illustrative of the present invention and non-limiting.

### DETAILED DESCRIPTION

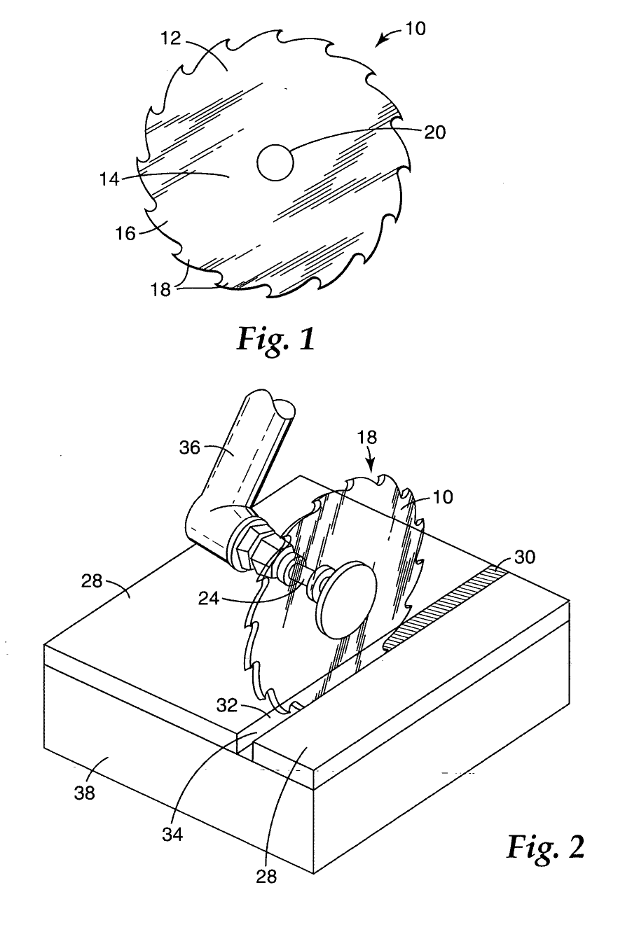

FIG. 1 is an elevational view of an exemplary circular blade 10 of the present invention. The circular blade 10 has a substantially planar body 12. The planar body 12 has a center portion 14 and a peripheral portion 16. The center portion 14 includes a mounting hole 20 at or near its center. The mounting hole 20 can be used to affix the circular blade 10 to a mandrel to form a cutting tool that can be mounted to a rotary tool, such as, for example, a drill. The peripheral portion 16 includes a plurality of polymeric cutting teeth 18.

FIG. 2 is a perspective view of an exemplary circular blade 10 of the present invention mounted on a right-angle drill 36. Substrate 28 is affixed to a substrate support 38 and has a butt joint 32 where two panels of the substrate 28 meet. The butt joint 32 forms an elongated opening 34 between the two panels of the substrate 28. The butt joint 32 in the substrate is filled with a sealant or coating 30. As shown in FIG. 2, the circular blade 10 can be used to remove sealant 30 from a substrate 28 and the substrate support 38.

In some embodiments, the substrate covering the substrate support is an airplane skin having a faying surface. The substrate can be, for example, an access panel on an aircraft wing or fuselage, or part of an engine cowling. In other embodiments, the substrate is a floor or ceiling panel, such as, for example, floor panels of an airplane's galley. In some embodiments, the substrate support may be a support structure, such as, for example, a beam or girder. The support structure can be the frame of an aircraft wing or floor joists in the interior of an airplane.

Embodiments of the present invention can be used to remove material from a variety of substrates. Examples of such substrates include, but are not limited to, metals, including aluminum (e.g., alclad aluminum, etc.), steel, etc.; composites, including carbon-carbon composites, fiberglass, glass reinforced epoxy, etc.; and glass. The substrate can be coated or uncoated. Examples of coated substrates include primed and/or painted substrates.

The substrate and/or substrate coating is typically harder than the material intended to be removed from it. In some embodiments, the substrate and/or substrate coating may be slightly damaged after incidental contact with the circular blade of the present invention. In other embodiments, the substrate and/or substrate coating can remain essentially undamaged after incidental contact.

The circular blade can be used to remove at least some, a portion, or substantially all of the material one desires to remove from a substrate. In some embodiments, an additional material removal step using an alternate cleaning tool, including, for example, another circular blade of the present invention, may precede or follow the use of the circular blade of the present invention. In other embodiments, the circular blade is used in combination with chemical means.

The substrate may be part of an object such as, for example, a vehicle or structure. Examples of such vehicles include, for example, aircraft, watercraft, and land vehicles.

Examples of materials that can be removed using the circular blade of the present invention include sealants, coatings, etc. Examples of specific sealants include, for example, polysulfides, room temperature vulcanate (RTV), silicone sealants, polyurethanes, butyl mastic compounds, caulks such as acrylic latex caulks, styrene-butadiene copolymer rubbers, styene-ethylenebutylene block copolymer and terpolymer rubbers, polyisoprene, polychloroprene, olefinic elastomers, polyester elastomers, polyamide elastomers, and blends and copolymers thereof. Examples of specific coatings that can be removed include, for example, elastomeric coatings and heat ablative coatings. The method of the invention is particularly useful in removing materials such as sealants from metal substrates.

Materials intended for removal by the circular blade will typically be present in considerable depths in elongated openings (e.g., butt joints or seams) within the substrate. For example, depending on the application, the material to be removed may have a thickness of at least about 0.5 millimeter. The thickness of the material is measured in the plane parallel to the circular blade during material removal (i.e., perpendicular to the axis of rotation). In some embodiments, the material to be removed can have a thickness of at least about 5 millimeters. In yet further embodiments, the material to be removed can have a thickness of at least about 15 millimeters. Frequently the material to be removed will have a thickness in the range of about 0.5 millimeter to about 20 millimeters. The thickness of the material to be removed can be greater than, equal to, or less than the depth of the elongated channel in the substrate.

In addition to a variety of depths of materials to be removed, materials intended for removal by the circular blade of the present invention will typically be present within narrow elongated openings having a variety of widths (e.g., butt joints or seams). The width of the elongated opening is measured in a plane parallel to the axis of rotation of the circular blade during material removal (i.e., perpendicular to the plane of the circular cutter). For example, depending on the application, the elongated opening from which material is to be removed can have a width that is less than about 1.5 millimeter. In other embodiments, the elongated opening from which material is to be removed can have a width that is less than about 10 millimeters. In yet further embodiments, the elongated opening from which material is to be removed can have a width that is less than about 18 millimeters. The elongated opening from which material is to be removed typically has a width that is in the range of about 1.5 millimeter to about 18 millimeters.

The material to be removed using the circular blade of the present is removed, at least in part, via cutting by the polymeric cutting teeth of the present invention. The term “cutting teeth” refers to a plurality of teeth having at least one substantially sharp edge that is capable of penetrating a material and dividing the material into parts. The polymeric cutting teeth can be formed in a variety of shapes and sizes known to those in the art, including, for example, varying gullet dimensions, cutting surface angles, teeth counts, and tooth geometry. For example, the polymeric cutting teeth can be formed in two-dimensions or three-dimensions. A two-dimensional tooth is characterized as having a cutting surface that is perpendicular to the planar body of the circular blade. Laser cutting or die cutting typically form a two-dimensional toothed circular blade. A three-dimensional tooth is characterized as having a cutting surface that is acute or obtuse (i.e., beveled) relative to the planar body of the circular blade.

In addition to varying the shape of the cutting surface and quantity of polymeric cutting teeth, the kerf of the circular blade can be made larger than the thickness of the center portion of the circular blade. The term “kerf” refers to the measurement between the two widest points of the plurality of polymeric cutting teeth (i.e., the width of the cutting path made by the circular blade). The kerf can be made wider than the center portion of the circular blade in a variety of ways, including, for example, by molding or machining the polymeric cutting teeth, or by inducing a permanent bend in the teeth relative to the plane of the circular blade body. In some embodiments the kerf is approximately equal to the width of the elongated opening from which material is to be removed. The kerf can also be substantially less than the width of the elongated opening from which material is to be removed.

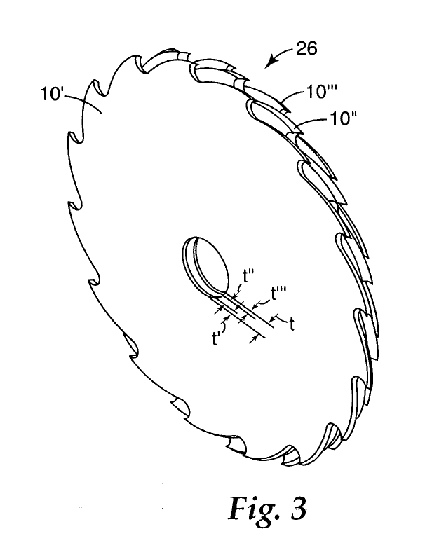

FIG. 3 is a perspective view of a dado blade 26 formed by combining circular blades of the present invention. As shown in FIG. 3, the dado blade 26 comprises a set of three circular blades 10′, 10″, 10′″ that are stacked. A mandrel (not shown) can be used to connect the three circular blades 10′, 10″, 10′″, having a thickness of t′, t″, and t′″, respectively, to form a cutting tool having an overall thickness (i.e., kerf) of t. The selection of blade thicknesses and quantity of circular blades used in the dado blade can be adjusted to form dado blades with varying thicknesses. In some applications, a dado blade is formed from a combination of circular blades to form a thickness that is approximately equal to the width of the elongated opening from which material is to be removed.

In some embodiments, the design of the circular blade is determined, at least in part, by the configuration of the material to be removed. For example, if the material to be removed is positioned in close proximity to interfering objects, a circular blade with a small diameter may be preferred for optimal access. In other applications, a larger diameter circular blade may be desired. In some embodiments, the circular blade has an outer diameter of at least about 25 millimeters. In yet further embodiments the circular blade has an outer diameter of at least about 50 millimeters. In some embodiments, the circular blade has an outer diameter that is less than about 150 millimeters. In yet further embodiments the circular blade has an outer diameter that is less than about 100 millimeters. The circular blade typically has an outer diameter in the range of about 50 millimeters to about 100 millimeters.

The circular blade of the present invention comprises cutting teeth comprising polymeric material. Such polymers may be thermoplastic or thermosetting and can be formed into cutting teeth using means known to those skilled in the art. If the polymer selected is thermoplastic, for example, the cutting teeth can be formed by an injection molding process. If a thermosetting polymer is selected, for example, a fabrication method known in the art as “reaction injection molding” may be employed. In other embodiments, a thermosetting polymer may be selected that is processable via injection molding techniques, followed by a crosslinking step such as exposing the molded article to either elevated temperature, UV, or to other reactive environments known to those in the art. Examples of useful thermosets include, but are not limited to, epoxies, phenol-formaldehydes, urea-formaldehydes, melamine-formaldehydes, polyurethanes, allyls, and polyesters.

In some embodiments, the circular blade comprises a rigid thermoplastic polymer. Examples of useful polymers include, but are not limited to, polyolefins, polyamides, polyesters, polysulfones, poly(ether ether ketones), and polyetherimides. In certain embodiments, the circular blade comprises polyetherimide polymers, such as those commercially available under the trade designation “ULTEM” from GE Plastics, Pittsfield, Mass. The use of substantially transparent or translucent materials can be used for applications in which it may be beneficial to have a view through the circular blade during use.

In some embodiments, the polymeric cutting teeth of the circular blade comprise a combination of materials that form a composite structure (e.g., a laminate). The entire circular blade or a portion of the article (such as the peripheral portion, for example) may optionally further comprise an additive, such as, for example, lubricants, pigments, dyes, fillers, and mechanical reinforcing agents.

In some embodiments, the polymeric cutting teeth consist essentially of a thermoplastic or thermoset polymer. In the context of the present invention, the term “consisting essentially of means the polymeric cutting teeth of the invention exclude only those materials or additives that would alter the hardness, flexural modulus, or toughness of the polymeric cutting teeth of the invention by more than 10 percent. In the specific context of this invention, this means that the inventive polymeric cutting teeth would not comprise a significant amount of hard materials, such as, for example, steel. In some embodiments, the circular blade, including the center portion and peripheral portion, consists essentially of a thermoplastic or thermoset polymer.

In some embodiments, the polymeric cutting teeth are made from a polymer have a flexural modulus of at least about 1,000 MPa at 23 degrees Celsius according to ASTM D790-98 (published March 1999). In other embodiments, the polymeric cutting teeth are made from a polymer have a flexural modulus of at least about 2,000 MPa at 23 degrees Celsius according to ASTM D790-98. Such relatively stiff materials may be used in order to avoid deformation of the polymeric cutting teeth either by inertial forces imparted by a rotary tool or by impaction forces exerted upon the teeth's encounter with the material to be removed.

The material for the cutting teeth can be selected so that it is not so hard as to cause damage to the substrate when removing material from the substrate. In some embodiments, the polymeric cutting teeth have a hardness that is no greater than 130 Rockwell M according to ASTM D785-03 (Procedure A; published January 2004). In other embodiments, the polymeric cutting teeth have a hardness that is no greater than 120 Rockwell M according to ASTM D785-03. In yet further embodiments, the polymeric cutting teeth have a hardness that is no greater than 110 Rockwell M according to ASTM D785-03.

In some embodiments, the polymeric cutting teeth are made from a polymer having a toughness of at least about 15 joules/meter according to ASTM D256A-97 (published May 1998) Izod Impact Test. When this test method is referenced to herein it is meant to refer only to the portion of the test performed using notched specimens. In other embodiments, the polymeric cutting teeth are made from a polymer having a toughness of at least about 30 joules/meter according to ASTM D256A-97. In some embodiments, the polymeric cutting teeth are made from a polymer have a heat deflection temperature of at least about 100 degrees Celsius according to ASTM D648-98c (published April 1999) at a loading of 1.82 MPa. In other embodiments, the polymeric cutting teeth are made from a polymer have a heat deflection temperature of at least about 175 degrees Celsius according to ASTM D648-98c.

The center portion of the circular blade of the present invention can be made from the same material used for the cutting teeth, or a different material. In some embodiments, the center portion of the circular blade extends to the base of the cutting teeth. The center portion can be made from a variety of materials, including, for example, plastic, metal, wood, ceramic, and glass. The center portion can be integrally formed with the polymeric cutting teeth, or may be formed independently of the polymeric cutting teeth. In some embodiments, the center portion is placed in the mold that forms the peripheral portion and becomes embedded in the material that forms the peripheral portion. In other embodiments, the entire circular blade is integrally formed in a mold. In yet further embodiments, the circular blade, both center and peripheral portions, is cut from a sheet-like piece of polymer material having a substantially uniform composition.

The center portion of the circular blade can have a mounting hole for attachment to a mandrel. As shown in FIG. 2, the circular blade 10 can be connected to mandrel 24 to form a cutting tool 18. The cutting tool 18, in turn, can be connected to a rotary tool 36. The cutting tool can be fastened to the mandrel using means known in the art, including, for example, a mechanical fastener (e.g., bolt, screw, nut, etc.). In some embodiments, discs or washers can be used on one or both sides of the center portion to increase clamping pressure between the mandrel and circular blade. The discs or washers can also be used to control cut depth or provide lateral support to circular blade. A key or other known locking device can also be used to prevent the circular blade from spinning about the mandrel.

The circular blade of the present invention can be used with a variety of rotary tools. Examples of useful rotary tools that can be used include but are not limited to pneumatic and electric power tools. The rotary tool can be hand tools or otherwise. In some embodiments, the rotary tool is selected to drive the circular blade (under no load) in the range of about 500 to about 3,000 RPM with sufficient torque to maintain a rotational speed under load of at least about 200 RPM. An exemplary tool for use with the circular blades of the present invention is Ingersoll-Rand Model Number QA0859D, a 90 degree angle head drill that operates at about 850 RPM under no load and is commercially available from Ingersoll-Rand Company, Montvale, N.J.

Advantages and other embodiments of this invention are further illustrated by the following example, but the particular materials and amounts thereof recited in these examples, as well as other conditions and details, should not be construed to unduly limit this invention. For example, the shape, size, composition, and arrangement of the polymeric cutting teeth can be varied. All parts and percentages are by weight unless otherwise indicated.

### EXAMPLE

Circular blades according to the present invention were formed by laser cutting circular blades with a variety of cutting teeth designs from sheets of “ULTEM 1000”, available from GE Plastics, Pittsfield, Mass. The sheets measured 0.89 millimeter and 1.58 millimeter thick. The circular blades had an outside diameter of about 75 millimeters and were made with a 9.53 millimeter mounting hole at the center of the center portion.

Test substrates were created by adhering 51 millimeter wide by 279 millimeter long by 1.58 millimeter thick plates of 6061T6 aluminum adjacent to one another onto 305 millimeter wide by 457 millimeter long by 0.81 millimeter thick substrate supports of 2024 T3 aluminum. The test substrate support was painted with an aerospace primer and topcoat system according to Boeing Specifications BMS 10-79 Type II Class B Grade A and BMS 10-60 Type II Class B Grade A. The butt joints formed between the substrate panels were filled with P/S 870-B-2 aerospace sealant available from PRC-Desoto International, Phoenix, Ariz.

The circular blades were mounted onto a “3M BRAND MANDREL 990” available from 3M Company, St. Paul, Minn. In some tests, the circular blades were mounted in a dado configuration comprising two circular blades. A polymeric spacer was used on both sides of the circular blades. The circular blades were run on a variety of pneumatic tools, including an 850 rpm Ingersoll-Rand Model QA0859D right angle drill, commercially available from Ingersoll-Rand Company, Montvale, N.J.

The circular blades removed the aerospace sealant and visual inspection of the butt joints with a 10× magnifying glass did not reveal any paint removal

It is to be understood that even in the numerous characteristics and advantages of the present invention set forth in above description and examples, together with details of the structure and function of the invention, the disclosure is illustrative only. Changes can be made to detail, especially in matters of shape, size and arrangement of the polymeric cutting teeth and methods of use within the principles of the invention to the full extent indicated by the meaning of the terms in which the appended claims are expressed and the equivalents of those structures and methods.

What is claimed is:

1. A circular blade comprising a substantially planar body having a center portion and a peripheral portion, said peripheral portion comprising a plurality of rigid polymeric cutting teeth having a thickness in the range of 0.5 to 4 millimeters and a hardness not greater than 130 Rockwell M.

2. The circular blade of claim 1 wherein said center portion comprises a polymeric material.

3. The circular blade of claim 1 wherein said center portion comprises a mounting hole having a diameter in the range of 6 to 20 millimeters.

4. The circular blade of claim 1 wherein said rigid polymer cutting teeth have a hardness not greater than 120 Rockwell M.

5. The circular blade of claim 1 wherein said rigid polymeric cutting teeth comprise a thermoplastic.

6. The circular blade of claim 1 wherein said rigid polymeric cutting teeth comprise a thermoset.

7. The circular blade of claim 1 wherein said rigid polymeric cutting teeth comprise a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide.

8. The circular blade of claim 1 wherein said rigid polymeric cutting teeth consist essentially of a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide.

9. A cutting tool comprising said circular blade of claim 1.

10. A cutting tool comprising a plurality of said circular blades of claim 1.

11. A circular blade consisting essentially of a rigid polymeric body having a thickness in the range of 0.5 to 4 millimeters and hardness not greater than 130 Rockwell M, said polymeric body comprising a center portion having a mounting hole and a peripheral portion having a plurality of cutting teeth.

12. The circular blade of claim 11 wherein said rigid polymeric body comprises a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide.

13. A cutting tool comprising said circular blade of claim 11.

14. The cutting tool of claim 13 further comprising a mandrel adapted to cooperate with said mounting hole to affix said circular blade to said cutting tool.

15. A cutting tool comprising a plurality of said circular blades of claim 11 cooperating to form a dado blade having a thickness in the range of 1 to 18 millimeters.

16. A method comprising:
providing a circular blade comprising a substantially planar body having a center portion and a peripheral portion, said peripheral portion comprising a plurality of rigid polymeric cutting teeth having a thickness in the range of 0.5 to 4 millimeters;
providing a substrate having a material to be removed;
rotating said circular blade;
contacting at least a portion of said material to be removed with said polymeric cutting teeth of said circular blade.

17. The method of claim 16 wherein said polymeric cutting teeth comprise a polymer selected from at least one of epoxy, phenol-formaldehyde, urea-formaldehyde, melamine-formaldehyde, polyurethane, allyls, polyester, polyolefins, polyamide, polysulfone, poly(ether ether ketone), and polyetherimide.

18. The method of claim 16 wherein said substrate comprises a metal and the material to be removed comprises a sealant.

19. The method of claim 18 wherein said substrate comprises a butt joint having an elongated opening, and at least a portion of said sealant is positioned within said elongated opening.

20. The method of claim 19 wherein said substrate is part of an aircraft.
